(19) United States
(12) Patent Application Publication
(10) Pub. No.: US 2026/0121893 A1
(43) Pub. Date: Apr. 30, 2026

(54) AI/ML-BASED JOINT DENOISING AND COMPRESSION OF CSI FEEDBACK

(71) Applicant: InterDigital Patent Holdings, Inc., Wilmington, DE (US)

(72) Inventors: Akshay Malhotra, San Jose, CA (US); Teng-Hui Huang, New Taipei (TW); Shahab Hamidi-Rad, Sunnyvale, CA (US)

(73) Assignee: InterDigital Patent Holdings, Inc., Wilmington, DE (US)

(21) Appl. No.: 19/118,546

(22) PCT Filed: Oct. 6, 2023
(86) PCT No.: PCT/US2023/034674

§ 371 Date: Apr. 4, 2025

Related U.S. Application Data
(60) Provisional application No. 63/413,886, filed on Oct. 6, 2022.

(51) Int. Cl. H04L 25/08; H04L 5/00

(52) U.S. Cl. CPC H04L 25/08; H04L 5/0048

(57) ABSTRACT

Joint denoising and compression of channel state information (CSI) feedback may be performed. An example device may include a processor configured to perform one or more actions. The device may receive configuration information that indicates a latent mode of operation and an encoder model. The device may receive CSI reference signals from a network node. The device may generate an estimated channel matrix based on the CSI reference signals. The device may generate a latent representation of the estimated channel matrix based on the latent mode of operation and the encoder model. The device may send the latent representation of the estimated channel matrix to the network node.

### CROSS-REFERENCE TO RELATED APPLICATIONS

This application claims the benefit of U.S. Provisional Application No. 63/413,886, filed Oct. 6, 2022, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein related to artificial intelligence/machine learning (AI/ML)-based joint denoising and compression of channel state information (CSI) feedback.

An example device (e.g., a wireless transmit-receive unit (WTRU)) may include a processor configured to perform actions. The device may receive configuration information that indicates a latent mode of operation and an encoder model. The device may receive CSI reference signals from a network node. The device may generate an estimated channel matrix based on the CSI reference signals. The device may generate a latent representation of the estimated channel matrix based on the latent mode of operation and the encoder model. The device may send the latent representation of the estimated channel matrix to the network node.

The device may generate vectors that represent a latent distribution associated with the estimated channel matrix.

The latent mode of operation may be a multiple latent mode. Generating the latent representation of the estimated channel matrix based on the latent mode of operation and the encoder model may involve: generating vectors that represent a latent distribution associated with the estimated channel matrix; and sampling a Gaussian distribution based on the vectors to generate latent samples associated with the estimated channel matrix, wherein the latent representation of the estimated channel matrix comprises the latent samples.

The latent mode of operation may be a distribution mode. Generating the latent representation of the estimated channel matrix based on the latent mode of operation and the encoder model may involve generating vectors that represent a latent distribution associated with the estimated channel matrix. The latent representation of the estimated channel matrix may include the vectors.

The device may estimate a value of a training loss parameter based on a property of the estimated channel matrix. The device may transmit the training loss parameter to the network node. The device may receive, from the network node, a gradient vector associated with the latent representation and the training loss parameter. The device may update the encoder model based on the gradient vector. The property of the estimated channel matrix comprises one or more of: a doppler spread, a delay spread, a signal to noise ratio (SNR), or a channel rank.

The device may determine, based on the estimated channel matrix, to perform CSI denoising. The device may transmit an indication of the determination to the network node. The latent representation of the estimated channel matrix may be generated further based on the determination.

The device may receive channel state information (CSI) reference signals comprising a noisy channel matrix. The noisy channel matrix may be encoded. A plurality of latent representation vectors may be output, based on the encoded noisy channel matrix. A Gaussian distribution may be sampled based on the latent representation vectors. The device may output a latent representation based on the sampling. The plurality of latent representation vectors may be transmitted to a network entity to be used for sampling a Gaussian distribution. An indication of a latent mode of operation may be received. The device may determine, based on the indication, whether to output a latent representation of the encoded noisy channel matrix. The plurality of latent representation vectors may be generated by a neural network. The neural network may have been subject to unsupervised training according to an unbiased estimate of decoder error. The unbiased estimate of the decoder error may include Stein's unbiased risk estimate (SURE) of the decoder error.

### BRIEF DESCRIPTION OF THE DRAWINGS

Furthermore, like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a configuration for channel state information (CSI) reporting settings, resource settings, and link.

FIG. 3 illustrates an example of codebook-based precoding with feedback information.

FIG. 4 is a block diagram illustrating an example technique for joint CSI compression and denoising.

FIG. 5 is a flow diagram illustrating an example technique for joint CSI compression and denoising.

FIG. 6 is a flow diagram illustrating an example technique for online training of an encoder model used for joint CSI compression and denoising.

FIG. 7 is a graph illustrating number of delay taps versus percentage of total power for indoor and outdoor datasets.

FIGS. 8A and 8B are graphs illustrating the mean square error (MSE)-compression trade-off in supervised settings.

FIGS. 9A and 9B are graphs illustrating reconstruction quality versus effective signal-to-noise ratio (SNR).

FIG. 10 is a table illustrating normalized reconstruction quality versus compression ratio in high and low signal-to-noise ratio (SNR) regimes.

### DETAILED DESCRIPTION

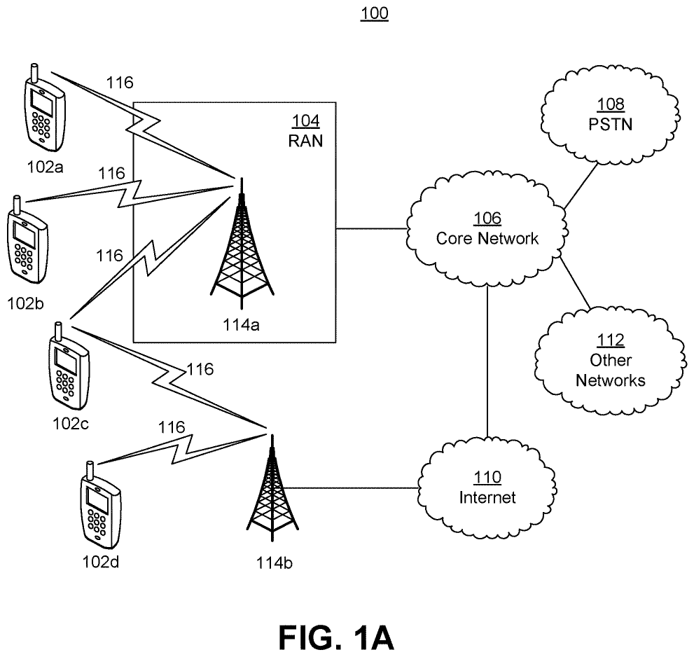

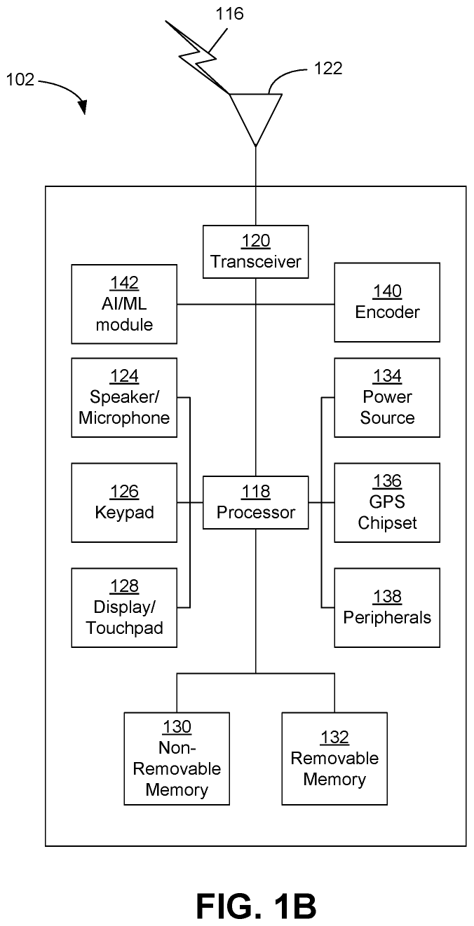

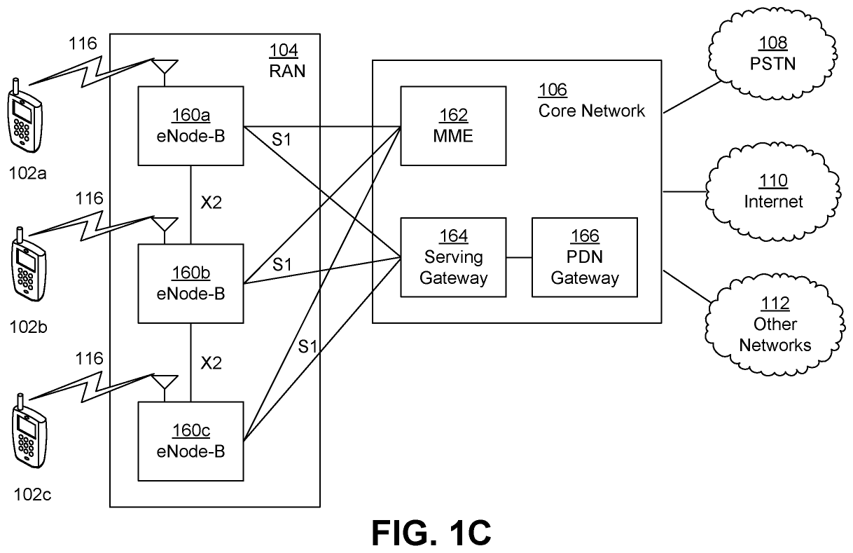

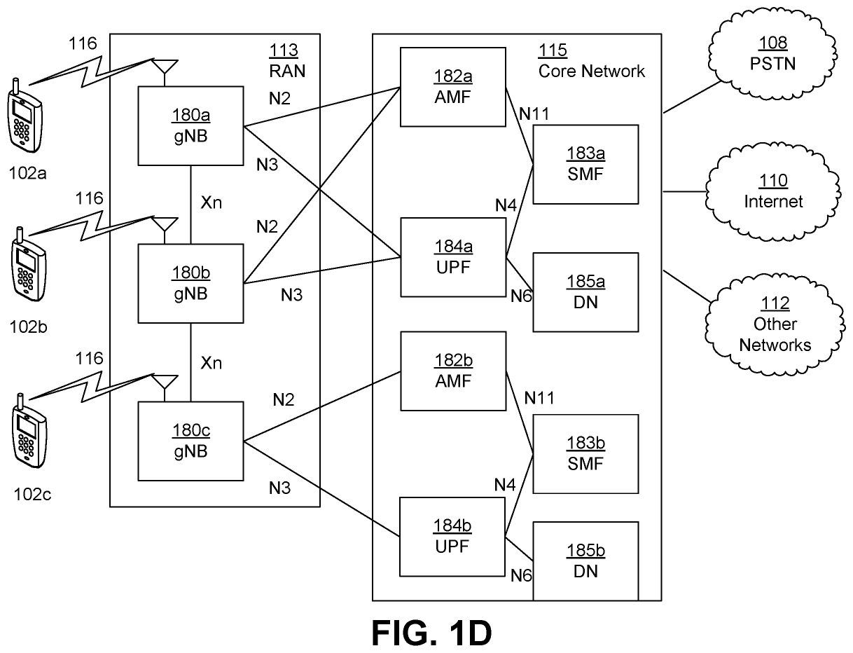

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, other peripherals 138, an encoder 140, and/or an artificial intelligence/machine learning (AI/ML) module 142, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

The encoder 140 and the AI/ML module 142 may be configured to perform joint denoising and compression of channel state information (CSI) signals, as explained further herein. The joint denoising and compression may be performed using supervised or unsupervised learning. Although illustrated as separate components, in some examples, the encoder 140 and/or the AI/ML module 142 may be implemented as part of the processor 118.

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Feature(s) associated with channel state information (CSI) reporting are provided herein. CSI may include at least one of the following: a channel quality index (CQI), a rank indicator (RI), a precoding matrix index (PMI), an L1 channel measurement (e.g., reference signal received power (RSRP) such as L1-RSRP, or signal to interference noise ratio (SINR)), a CSI reference signal (CSI-RS) resource indicator (CRI), a synchronization signal/physical broadcast channel (SS/PBCH) block resource indicator (SSBRI), a layer indicator (LI), and/or any other measurement quantity measured by the WTRU from the configured reference signals (e.g., CSI-RS, SS/PBCH block, or any other reference signal).

An example CSI reporting framework is provided herein. A WTRU may be configured to report CSI through an uplink control channel (e.g., on physical uplink control channel (PUCCH)). In some examples, a WTRU may be configured to report CSI on an UL PUSCH grant (e.g., at the request of a gNB). CSI-RS may cover the full bandwidth of a bandwidth part (BWP). CSI-RS may cover a fraction of a BWP. Whether the CSI-RS covers the full bandwidth or a fraction of a BWP may depend on a CSI-RS configuration. CSI-RS may be configured in a physical resource block (PRB) (e.g., each PRB within the CSI-RS bandwidth). CSI-RS may be configured in a PRB (e.g., every other PRB within the CSI-RS bandwidth). CSI-RS resources may be configured (e.g., in the time domain) as periodic, semi-persistent, or aperiodic. Semi-persistent CSI-RS may be similar to periodic CSI-RS. In semi-persistent CSI-RS, a resource may be (de-)activated by medium access control (MAC) control elements (CEs). In semi-persistent CSI-RS, a WTRU may report related measurements if (e.g., only if) the resource is activated. For aperiodic CSI-RS, a CSI report may be triggered. For example, the CSI report may be triggered by a request (e.g., in a DCI) for a CSI report. Periodic reports may be carried over the PUCCH. Semi-persistent reports may be carried on PUCCH or PUSCH. The reported CSI may be used by a scheduler. For example, the scheduler may use the reported CSI to allocate resource blocks (e.g., optimal resource blocks). The scheduler may allocate resource blocks based on the channel's time-frequency selectivity, determining precoding matrices, beams, transmission mode, and/or selecting suitable modulation coding schemes (MCSs). The reliability, accuracy, and/or timeliness of WTRU CSI reports may be involved in meeting ultra-reliable and low latency communications (URLLC) service standards (e.g., requirements).

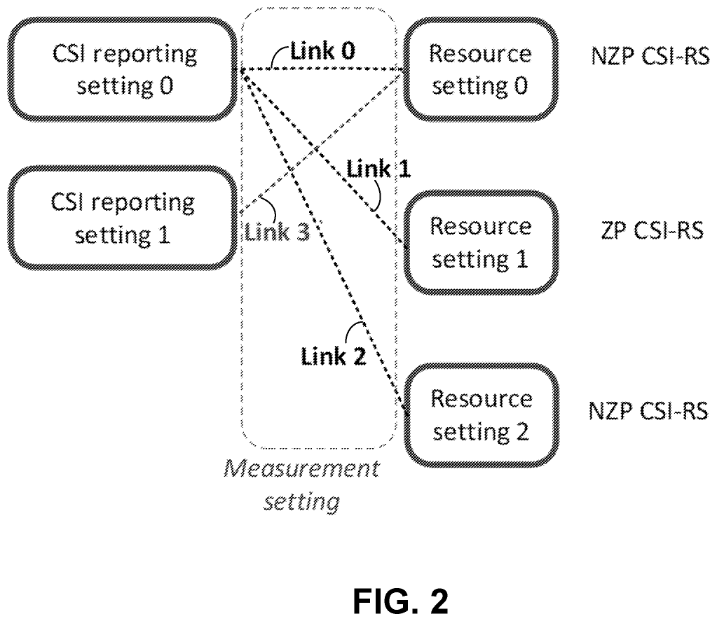

A WTRU may be configured with a CSI measurement setting. For example, the WTRU may receive configuration information from a network (e.g., from a gNB). The configuration information may include one or more CSI measurement settings (e.g., CSI measurement setting information). Based on the configuration information, the WTRU may perform one or more actions (e.g., receiving a signal, measuring an aspect of the signal, estimating a channel based on the measurement, reporting a measurement and/or an estimation of the channel to the network, and/or the like). The one or more actions may be indicated by the CSI measurement settings. The CSI measurement settings may include one or more CSI reporting settings, resource settings, and/or a link between one or more CSI reporting settings and one or more resource settings. FIG. 2 illustrates an example of a configuration for CSI reporting settings, resource settings, and a link between one or more CSI reporting settings and one or more resource settings.

A CSI measurement setting may include one or more configuration parameters. Example configuration parameters may include N CSI reporting settings (e.g., where N is greater than or equal to 1), M resource settings (e.g., where M is greater than or equal to 1), and/or a CSI measurement setting that links the N CSI reporting settings with the M resource settings. An example CSI reporting setting may include one or more of the following: time-domain behavior (e.g., aperiodic, periodic, and/or semi-persistent), frequency-granularity (e.g., at least for PMI and CQI), a CSI reporting type (e.g., PMI, CQI, RI, CRI, etc.), a PMI type (e.g., Type I or II, if PMI is reported), and/or a codebook configuration. An example resource setting may include one or more of the following: time-domain behavior (e.g., aperiodic, periodic, and/or semi-persistent), an RS type (e.g., for channel measurement and/or interference measurement), and/or S resource set(s) (e.g., where S is greater than or equal to 1). In some examples, a resource set (e.g., each resource set of the S resource set(s)) may include K resources (e.g., where K is greater than or equal to 1).

An example CSI measurement setting may include one or more of the following: a CSI reporting setting, a resource setting, and/or a reference transmission scheme setting (e.g., for CQI). For CSI reporting for a component carrier, one or more frequency granularities may be supported. Some example frequency granularities include wideband CSI, partial band CSI, and/or sub band CSI.

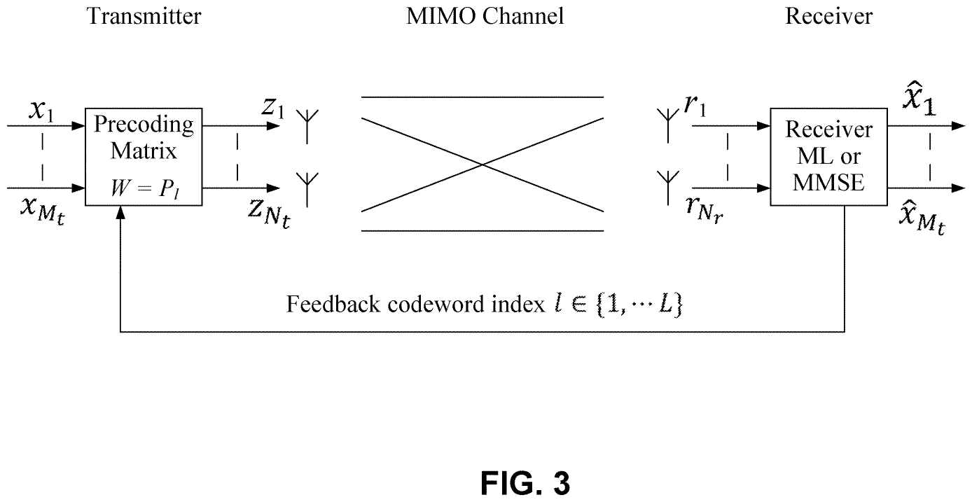

Feature(s) associated with codebook-based precoding are provided herein. FIG. 3 illustrates an example of codebook-based precoding with feedback information. The feedback information may include a precoding matrix index (PMI). The PMI may be referred to as a codeword index in the codebook.

As shown in FIG. 3, a codebook may include a set of precoding vectors/matrices for one or more ranks (e.g., each rank) and the number of antenna ports. One or more precoding vectors/matrices (e.g., each of the precoding vectors/matrices) may have its own index (e.g., so that a receiver may inform a transmitter of a preferred precoding vector/matrix index). The codebook-based precoding may have performance degradation (e.g., due to its finite number of precoding vector/matrix, for example, as compared with non-codebook-based precoding). Codebook-based precoding may be associated with lower control signaling/feedback overhead. Table 1 shows an example codebook for 2Tx.

TABLE 1
2Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

Example CSI processing criteria are provided herein. A CSI processing unit (CPU) may be referred to as a minimum CSI processing unit and a WTRU may support one or more CPUs (e.g., X CPUs). A WTRU with X CPUs may estimate X CSI feedbacks calculation in parallel. X may be a WTRU capability configuration. If a WTRU is requested to estimate more than X CSI feedbacks at the same time, the WTRU may perform X high priority CSI feedbacks (e.g., only X high priority CSI feedbacks and the rest may be not estimated).

The start and end of a CPU may be determined based on the CSI report type (e.g., aperiodic, periodic, or semi-persistent). For an aperiodic CSI report, a CPU may start to be occupied from the first orthogonal frequency-division multiplexing (OFDM) symbol after the PDCCH trigger until the last OFDM symbol of the PUSCH carrying the CSI report. For a periodic and semi-persistent CSI report, a CPU may start to be occupied from the first OFDM symbol of one or more associated measurement resources (e.g., not earlier than CSI reference resource) until the last OFDM symbol of the CSI report.

The number of CPUs occupied may be different based on the CSI measurement types (e.g., beam-based or non-beam based) as following: non-beam related reports (e.g., Kₛ CPUs when Kₛ CSI-RS resources in the CSI-RS resource set for channel measurement); beam-related reports (e.g., cri-RSRP, ssb-Index-RSRP, or none), for example, 1 CPU may be used irrespective of the number of CSI-RS resource in the CSI-RS resource set for channel measurement due to the CSI computation complexity being low or none may be used for P3 (e.g., downlink beam refinement procedure) operation or aperiodic tracking reference signal (TRS) transmission; for an aperiodic CSI reporting with a single CSI-RS resource, 1 CPU may be occupied; or for a CSI reporting Kₛ CSI-RS resources, Kₛ CPUs may be occupied as the WTRU needs to perform CSI measurement for each CSI-RS resource.

If the number of unoccupied CPUs (Nᵤ) is less than the number of CPUs (Nᵣ) to be used for CSI reporting (e.g., the number of CPUs needed for CSI reporting), the WTRU may drop CSI reporting based on priorities (e.g., in the case of UCI on PUSCH without data/HARQ) and/or the WTRU may report dummy information in Nᵣ-Nᵤ CSI reporting (e.g., based on priorities in other cases to avoid rate-matching handling of PUSCH).

Artificial intelligence (AI) may refer to the behavior exhibited by machines. Such behavior may mimic cognitive functions to sense, reason, adapt, and/or act. Machine learning (ML) may refer to the type of algorithms that solve a problem based on learning through experience (e.g., data) without explicitly being programmed to do so (e.g., by a configured set of rules). ML may be considered a subset of AI.

Different machine learning paradigms may be envisioned based on the nature of data or feedback available to the learning algorithm. For example, a supervised learning approach may involve learning a function that maps an input to an output based on a labeled training example (e.g., wherein each training example may include an input and the corresponding output). For example, an unsupervised learning approach may involve detecting patterns in the data with no pre-existing labels. For example, a reinforcement learning approach may involve performing a sequence of actions in an environment to increase (e.g., maximize) the cumulative reward. ML algorithms may be applied using a combination or interpolation of the above-mentioned learning approaches. For example, a semi-supervised learning approach may use a combination of a small amount of labeled data with a large amount of unlabeled data during training. In this regard, semi-supervised learning falls between unsupervised learning (e.g., with no labeled training data) and supervised learning (e.g., with only labeled training data).

Deep learning may refer to the class of ML algorithms that employ artificial neural networks loosely inspired from biological systems (e.g., deep neural networks (DNNs)). For example, DNNs may include a class of ML models inspired by the human brain. In DNNs, an input may be linearly transformed. In DNNs, an input may be passed through non-linear activation function(s) multiple times. DNNs may include multiple layers. For example, a layer (e.g., each layer) may include a linear transformation and/or non-linear activation function(s).

DNNs may be trained using training data (e.g., via a back-propagation algorithm). DNNs may be used in a variety of domains (e.g., speech, vision, natural language etc.) and in various machine learning settings (e.g., supervised, un-supervised, semi-supervised, and/or the like). The term AI/ML-based methods/processing may include the realization of behaviors and/or conformance to requirements by learning based on data (e.g., without explicit configuration of a sequence of steps of actions). Such methods may enable machines to learn complex behaviors (e.g., which might be difficult to specify and/or implement when using other methods).

An example of deep learning using evidence lower bound (ELBO) is provided herein. Probability distributions of data with practical interests may be problematic. Based on variational inference (e.g., with a properly chosen prior probability mass or density function chosen), a lower bound of the divergence between two probability distributions may allow efficient estimation. ELBO may be used in deep learning. For example, ELBO may be used to create influential generative models (e.g., such as a variational autoencoder and numerous variants). In supervised learning, ELBO may be used to estimate mutual information (e.g., when a prior distribution is chosen to be multivariate Gaussian).

Deep learning may be used for downlink CSI compression and/or reconstruction in massive MIMO CSI feedback. This use of deep learning may outperform other (e.g., existing) compressed sensing-based approaches (e.g., that rely on signal sparsity in the angular-delay domain that might not hold always in complicated real-world wireless environment). Some approaches may demonstrate improved reconstruction performance of CSI from angular-delay domain (e.g., in terms of the normalized mean square error (NMSE)), for example, compared to compressed sensing-based approaches.

An example loss function for a deep learning-based approach to jointly denoise and compress CSI feedback in an unsupervised learning fashion is provided herein. The loss function and associated estimators may be employed on existing deep learning-based models. For example, the loss function and the associated estimators may be employed without extra parameters. The loss function and the associated estimators may be employed without using (e.g., requiring) a centralized system design.

For compression, variational inference-based mutual information estimators for supervised classification may be used to control (e.g., explicitly control) the relevance compression trade-off. A low-dimensional latent representation of the noisy CSI may be formed. The low-dimensional latent representation of the noisy CSI may keep relevant information for reconstruction while discarding noise in the signal.

An example setup and dataset may be provided. A WTRU may receive CSI-RS (e.g., CSI-RS symbols) from a network node (e.g., a gNB). The WTRU may generate an estimated channel matrix based on the CSI-RS. For example, the WTRU may perform channel estimation on the CSI-RS. The channel estimate, Ĥ, may be a noisy version of the true channel, H. The channel estimate may be written as Ĥ=H+W, where W refers to the added noise. The noisy channel estimate may be used as training data. The noisy channel estimate may be a matrix. The size of the matrix may depend on the number of sub-carriers, number of transmit/receive antennas, and/or number of orthogonal frequency division multiplexing (OFDM) symbols. An example of valid matrix dimensions may be N_{C}×N_{R}×N_{T} (e.g., representing the number of sub-carriers (N_{C}), number of transmit antennas (N_{T}) and number of receive antennas (N_{R})).

Received reference symbols (e.g., CSI-RS) at a WTRU (e.g., during downlink communication) or a gNB (e.g., during uplink communication) may be corrupted with varying degrees of noise. The reference symbols may be used for CSI estimation. Accordingly, the estimated CSI may be affected by noise. As a result, the estimated CSI may not be suitable for evaluating the precoders, for CSI compression, and/or for combiners.

As described herein, CSI compression models may be trained (e.g., whether in an online or an offline fashion) when the input data is noisy. For example, estimated CSI may be simultaneously compressed and denoised. For example, a processor configured with an AI/ML algorithm may compress and denoise estimated CSI. For example, the AI/ML algorithm that compresses estimated CSI may also denoise the estimated CSI.

ML-based solutions for CSI compression and denoising may use datasets for training (e.g., for a wide range of channel conditions). It may be difficult to generate such large datasets and ensure that a single model can effectively operate in channel conditions (e.g., all channel conditions). Online training schemes may be utilized for fine-tuning or retraining models to specific channel conditions. General deep learning models may use a noisy input and a noise-free reference so that a channel can be effectively compressed and denoised. However, noise-free channels may not be available over the air.

Accordingly, techniques for simultaneously denoising and compressing the CSI data are provided herein. Techniques for training AI/ML models in an online fashion without noise free reference data are provided.

In estimation theory, in a standard noisy signal model (e.g., y=x+n where the noise n is additive Gaussian), there exists an unbiased estimate of the mean squared error between an estimator (e.g., \hat{X}=f(Y)) and a true signal (e.g., X). The unbiased estimate may be referred to as Stein's unbiased risk estimate (SURE). SURE may be used for unsupervised image denoising (e.g., for unsupervised image denoising where the estimator is parameterized with some deep learning models). Unsupervised learning may be possible in this case because an unbiased estimate of mean squared error (MSE) is available without knowledge of the ground truth labels. MSE may be used to assess the quality of ML.

SURE may apply to specific noise distributions (e.g., the exponential family). The first moment for SURE may be bounded. In some cases, SURE may not be used (e.g., the usage of SURE may be restricted in image processing). In some other cases, the usage of SURE may not be restricted (e.g., in wireless communications with additive Gaussian noise).

Feature(s) associated with preprocessing are provided herein. The noisy channel estimate (e.g., noisy CSI) may be pre-processed before being utilized for the training process. An example method for pre-processing is a fast Fourier Transform (FFT) of the channel matrix. For example, the FFT may be applied along any of the dimensions of the channel matrix. For example, the FFT may be applied along the transmit (Tx) and receive (Rx) antenna axes. The FFT may be applied along all available axes.

Feature(s) associated with deep-learning-based encoder are provided herein. The CSI may be a complex-valued matrix (e.g., with real and imaginary parts representative of I-Q samples). Due to the orthogonality of the I-Q channels, an example representation of the CSI matrix may be a real-value tensor with the last dimension equal to two, (e.g., images with two channels). The CSI data may be encoded with neural networks (e.g., deep convolutional neural networks (CNNs) or low-dimensional latent representations).

Feature(s) associated with joint denoising and compression are provided herein. For unsupervised denoising, SURE may be used as an unbiased estimate of MSE between the output of a decoder and the inaccessible true CSI. For example, the unbiased estimate of MSE may be expressed as Equation 1, below:

$$= {\vert {f}_{θ} ( \hat{H} ) - \hat{H} \vert}_{2}^{2} - K {σ}^{2} + 2 {σ}^{2} Div ( Φ ( \hat{H} ) ) \qquad Eq . 1$$

where Div(⋅) denotes the divergence, f_{θ}(⋅) denotes the encoder, σ² denotes the element-wise noise power, and Φ(⋅) denotes the composite function (e.g., including the encoder and the decoder).

For compression, a first surrogate upper bound of the mutual information (e.g., [symbol] (f_{θ}(Ĥ); Ĥ), assuming Gaussian priors) may be expressed as Equation 2, below:

$$( {f}_{θ} ( \hat{H} ) ; \hat{H} ) \leq - 0.5 \cdot {\sum }_{i = 1}^{K} [ 1 + log {v}_{θ , i}^{2} ( \hat{H} ) - {μ}_{θ , i}^{2} ( \hat{H} ) - {v}_{θ , i}^{2} ( \hat{H} ) ] , \qquad Eq . 2$$

where the encoder output vectors μ_{θ}, ν_{θ}=f_{θ}(Ĥ) as means and variances (independent) for Gaussian sampling y=μ_{θ}+ν_{θ}n, n˜N (0,I).

A second surrogate upper bound, denoted as [symbol] (f_{θ}(Ĥ); Ĥ), may be expressed as Equation 3, below (e.g., with the variational prior parameterized to be Gaussian mixture):

$$( {f}_{θ} ( \hat{H} ) ; \hat{H} ) \leq {E}_{x} [ {E}_{{x}^{′}} [ {\sum }_{{c}_{i}} {p}_{{c}_{i} ; x} log {\sum }_{{c}_{j}} {p}_{{c}_{j} ; {x}^{′}} {e}^{- \frac{1}{2 {v}_{θ}^{2} ( \hat{H} )} d ( {μ}_{{c}_{i} ; x} , {μ}_{{c}_{j} ; {x}^{′}} )} ] ] \qquad Eq . 3$$

where d(μ_{c}_{ᵢ}_{; x}, μ_{c}_{ⱼ}_{; x}) denotes the pair-wise distance function shown in Equation 4.

$$d ( {μ}_{{c}_{i} ; x} , {μ}_{{c}_{j} ; {x}^{′}} ) = {\vert {μ}_{{c}_{i} ; x} - {μ}_{{c}_{j} ; {x}^{′}} \vert}^{T} \vert {μ}_{{c}_{i} ; x} - {μ}_{{c}_{j} ; {x}^{′}} \vert \qquad Eq . 4$$

A first joint objective function (e.g., referred to as variational information bottleneck (VIB)+SURE, or VIB mode) may be expressed as Equation 5.

$${L}_{vsure} := γ ( \hat{H} ; {f}_{θ} ( \hat{H} ) ) + , \qquad Eq . 5$$

A second joint objective function may be referred to as nonlinear information bottleneck (NIB)+SURE or NIB mode.

Feature(s) associated with online training are provided herein. An example forward pass at the WTRU (e.g., encoder) may be provided. The WTRU may be configured by a network node (e.g., a gNB) to perform CSI compression and denoising based on feedback using an AI/ML encoder. The WTRU may receive reference signals (e.g., CSI-RS, DM-RS) from the network node (e.g., the gNB). The WTRU may generate an estimated channel matrix based on the reference signals. For example, the WTRU may perform channel estimation using the reference signals. The WTRU may generate a dataset (e.g., that may be utilized for model training).

The WTRU may receive a trigger (e.g., from the gNB) to start the online training process. In an example, the WTRU may receive a flag (e.g., an information bottleneck (IB)-Flag) (e.g., from the gNB) indicating a structure of the information bottleneck to be utilized. For example, the structure of the information bottleneck to be utilized may be (pre) configured or dynamically signaled. The flag may indicate whether the model is trained and/or operated using the first joint objective function or the second joint objective function.

The WTRU may determine which structure of the information bottleneck to use. In this case, the WTRU may transmit the flag (e.g., to the gNB) to inform the gNB of the structure of the information bottleneck that the WTRU determined to use. The trigger and/or the flag may be transmitted using physical downlink control channel (PDCCH), PUCCH, DCI, and/or other control signals. The flag may indicate if an encoder of the WTRU (e.g., the encoder 140) should be in a multiple latent mode or a distribution mode.

In the distribution mode, the WTRU may encode the noisy channel matrix using the encoder model provided herein. If the latent mode of operation is the distribution mode, the WTRU may generate a latent representation of the estimated channel matrix by generating vectors that represent a latent distribution associated with the estimated channel matrix. For example, in the distribution mode, the WTRU may obtain the μ_{θ},

$${v}_{θ}^{2}$$

vectors as outputs of the encoder model. The μ_{θ},

$${v}_{θ}^{2}$$

vectors may be a latent representation of the estimated channel matrix. In the distribution mode, the WTRU may transmit the μ_{θ},

$${v}_{θ}^{2}$$

vectors to the gNB.

In multiple latent mode, the WTRU may encode the estimated noisy channel matrix using the encoder model provided herein. If the latent mode of operation is the multiple latent mode, the WTRU may generate a latent representation of the estimated channel matrix by generating vectors that represent a latent distribution associated with the estimated channel matrix. For example, in multiple latent mode, the WTRU may obtain the μ_{θ},

$${v}_{θ}^{2}$$

vectors (e.g., as outputs of the encoder model). In multiple latent mode, the WTRU may sample a Gaussian distribution

$$( e . g . , N ( {μ}_{θ} , {v}_{θ}^{2} ) ) .$$

For example, the WTRU may sample a Gaussian distribution based on the vectors and/or based on a determined number of latent representations. The WTRU may sample the Gaussian distribution based on the vectors to generate latent samples associated with the estimated channel matrix. The latent representation of the estimated channel matrix may include the latent samples. The WTRU may transmit the latent samples (e.g., the multiple latent representations) to the gNB.

The WTRU may be configured to utilize one or more estimated channel properties (e.g., doppler, delay spread, SNR, channel rank, etc.). The WTRU may estimate a value of a training loss parameter based on a property of the estimated channel. For example, the WTRU may be configured to use a rule-based or ML-based model to estimate the value of the training loss parameter (e.g., SURE related parameters, loss weighting and/or noise variance/power). The WTRU may estimate (e.g., constantly compute) the training loss parameter value. The WTRU may transmit the training loss parameter to a network node. For example, the WTRU may send the updated value at each frame. The WTRU may send the updated value asynchronously (e.g., when the new value is different from the previously signaled value by a large margin).

From the network side (e.g., the gNB side), in the distribution mode, the gNB may obtain μ_{θ},

$${v}_{θ}^{2}$$

vectors from a WTRU. The gNB may use the μ_{θ},

$${v}_{θ}^{2}$$

vectors to form one or more latent representations. The gNB may then use a decoder for estimating the de-compressed channel. The gNB may compute a loss function and/or gradient(s) using the training loss parameter(s) signaled by the WTRU. The gNB may transmit gradient vector(s) (e.g., two gradient vectors corresponding to each of μ_{θ},

$${v}_{θ}^{2}$$

vectors) to the WTRU. The WTRU may receive, from the network node, the gradient vector(s) associated with the latent representation and the training loss parameter. The gradient vector(s) may be used (e.g., by the WTRU) to update the encoder model.

In the multiple latent mode, the gNB may receive a plurality of latent representations. In this case, for each latent representation received, the gNB may use the decoder to estimate the de-compressed channel. The gNB may compute the loss function and the gradients using parameters signaled by the WTRU. For each latent representation, the gNB may transmit a gradient vector back to the WTRU. The WTRU may use the gradient vector to update the encoder model.

The encoder neural network may use the noisy channel estimate (e.g., Ĥ) as the input. The encoder neural network may output a mean vector (e.g., μ_{θ}(Ĥ)) and a second output

$$( e . g . , {v}_{θ}^{2} ( \hat{H} ) ) .$$

The dimensionality of

$${v}_{θ}^{2} ( \hat{H} )$$

may depend on the IB-Flag. In the VIB mode, a diagonal covariance matrix may be used. In the NIB mode,

$${v}_{θ}^{2} ( \hat{H} )$$

may be represented as a scaler.

The overall forward pass flow at the WTRU may be expressed as Equation 6, below.

$$\hat{H} \to {enc}_{θ} ( \hat{H} ) \to ( {μ}_{θ} , {v}_{θ}^{2} ) \qquad Eq . 6$$

Example data transmission(s) from WTRU to gNB are provided. The WTRU may receive configuration information that indicates a latent mode of operation and an encoder model. For example, the WTRU may receive a flag (e.g., at the start of training) to indicate if the latent mode of operation (e.g., the encoder output) should be in a multiple latent mode or a distribution mode. The WTRU may generate a latent representation (e.g., vectors or latent samples) of the estimated channel matrix based on the latent mode of operation and the encoder model. The dimensionality of the data transmitted from the WTRU to gNB may vary depending on the latent mode of operation. For example, in the distribution mode, the WTRU may encode the noisy channel matrix using an encoder model (proposed herein) to obtain the mean (e.g., μ_{θ}) and variance

$$( e . g . , {v}_{θ}^{2} )$$

vectors as outputs or the encoder. The WTRU may transmit the output vectors to the gNB. In the multiple latent mode, the WTRU may encode the estimated noisy channel matrix using an encoder model (proposed herein) to obtain the mean (e.g., μ_{θ}) and variance

$$( e . g . , {v}_{θ}^{2} )$$

vectors. The WTRU may sample a Gaussian distribution

$$( e . g . , N ( {μ}_{θ} , {v}_{θ}^{2} ) )$$

based on a number of latent representations for which the WTRU is configured. The number of latent representation(s) may be expressed as Equation 7, below:

$${z}_{d} = {μ}_{θ} + {v}_{θ} \cdot {ε}_{d} \qquad Eq . 7$$

where ε_{d}˜N(0, I_{d}) are random samples from a zero-mean Gaussian distribution with covariance equal to a d-dimensional identity matrix. The latent representation(s) of the estimated channel matrix may be sent (e.g., transmitted) to a network node (e.g., in the desired format).

The WTRU may transmit other data and/or parameters (e.g., to enable loss and gradient computation). For example, the WTRU may transmit the received noise variance/power, the input channel matrix Ĥ, and/or other parameters associated with SURE loss.

An example forward pass at the gNB (e.g., decoder) is provided herein. In some examples, (e.g., depending on the latent mode of operation) the gNB may utilize the received sampling vectors

$$( {μ}_{θ} , {v}_{θ}^{2} )$$

and generate the required multiple samples. In some examples, (e.g., in multiple latent mode) the gNB decoder may use a random Gaussian sampling module to generate the samples (e.g., z_{d}=μ_{d}+ν_{d}·ε_{d}, where ε_{d}˜N(0, I_{d}) are random samples from zero-mean Gaussian distribution with covariance equal to a d-dimensional identity matrix).

The sampling mechanism can be performed multiple times. For example, if the sampling is performed S times, the latent representations (e.g., generated by the gNB decoder) may be expressed as Equation 8, below.

$${\overline{z}}_{d} = \frac{1}{S} {\sum }_{s = 1}^{S} {z}_{d} \qquad Eq . 8$$

The decoder may reconstruct the noisy CSI \tilde{H} with a deep architecture, with z_{d} as an input, \tilde{H} as the output, and parameterized as φ. The reconstructed noisy CSI may be expressed as Equation 9, below.

$$\tilde{H} = {dec}_{ϕ} ( {z}_{d} ) \qquad Eq . 9$$

Feature(s) associated with training loss and gradient backpropagation are provided herein. The WTRU may estimate a value of a training loss parameter based on a property of the estimated channel matrix. For example, given z_{d}, \tilde{H}, and Ĥ, the training loss parameter (e.g., loss functions corresponding to VIB+SURE or NIB+SURE) may be calculated (e.g., by the WTRU). The training loss parameter may be transmitted to a network node. The loss parameter may be passed to gradient descent-based learning (e.g., standard gradient descent-based learning) for backpropagation.

Feature(s) associated with gradient flow are provided herein. The decoder (e.g., at the network node) may update the parameter φ. The network node may determine gradient vector(s) associated with the latent representation and the training loss parameter. The decoder may transmit the gradient vector(s) back to the encoder (e.g., WTRU). The data transmitted by the gNB may depend on the latent mode of operation. For example, the gNB may transmit two gradient vectors corresponding to each of μ_{θ} and ν_{θ} vectors in the distribution mode. For example, in the multiple latent mode, the gNB may send a gradient corresponding to each z_{d}. The WTRU may update the encoder model based on the gradient vector(s) (e.g., the gradient(s) may be used by the WTRU to update the encoder model).

Example inference(s) are provided. The WTRU may be configured (e.g., by the gNB) to perform the CSI feedback compression and denoising (e.g., using an AI/ML encoder). The WTRU may be configured to operate in a specified latent mode of operation (e.g., the multiple latent mode or the distribution mode).

The WTRU may determine to perform CSI denoising (e.g., jointly with CSI compression). For example, the WTRU may determine to perform CSI denoising based on the estimated channel matrix. The WTRU may transmit an indication of the determination to the network node. The latent representation of the estimated channel matrix may be generated based on the determination. The WTRU may receive a trigger (e.g., from the gNB). The trigger may indicate for the WTRU to perform (e.g., start) the CSI feedback with denoising.

The WTRU may receive reference signals from gNB (e.g., CSI-RS, DM-RS). The WTRU may perform channel estimation using the reference signals. The encoded CSI feedback may be transmitted to the gNB (e.g., based on latent mode of operation). The mean (e.g., μ_{θ}) and variance (e.g., ν_{θ}) vectors may be (re)transmitted (e.g., if operating in the distribution mode). One or more (e.g., multiple) sampled vectors may be transmitted (e.g., if operating in the multiple latent mode). The decoder (e.g., at the gNB) may utilize the received CSI feedback to reconstruct the channel (e.g., represented by \tilde{H}=dec_{φ}(z_{d})).

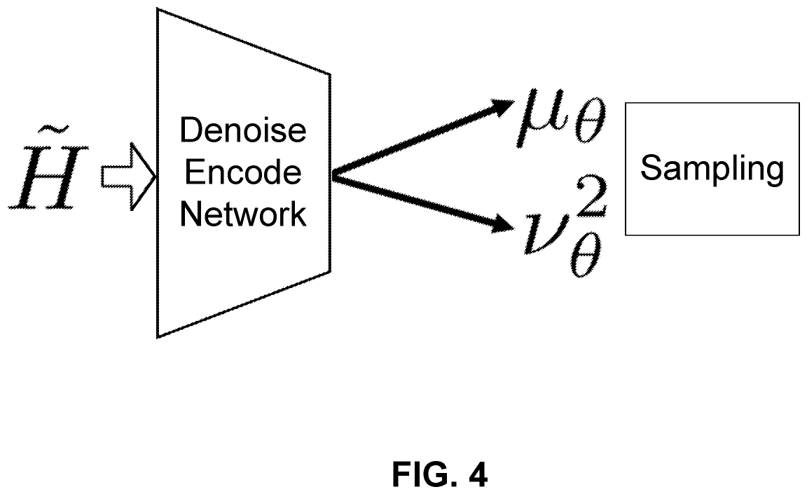

FIG. 4 is a block diagram illustrating an example technique for joint CSI compression and denoising. As illustrated, the estimated channel matrix (e.g., noisy channel matrix), \tilde{H}, may be an input to a denoising and encoding network (e.g., a joint denoising and compression network). The output of the denoising and encoding network may be the mean and variance vectors (e.g., μ_{θ} and ν_{θ}), as shown. The vectors may be used for sampling (e.g., to generate latent samples).

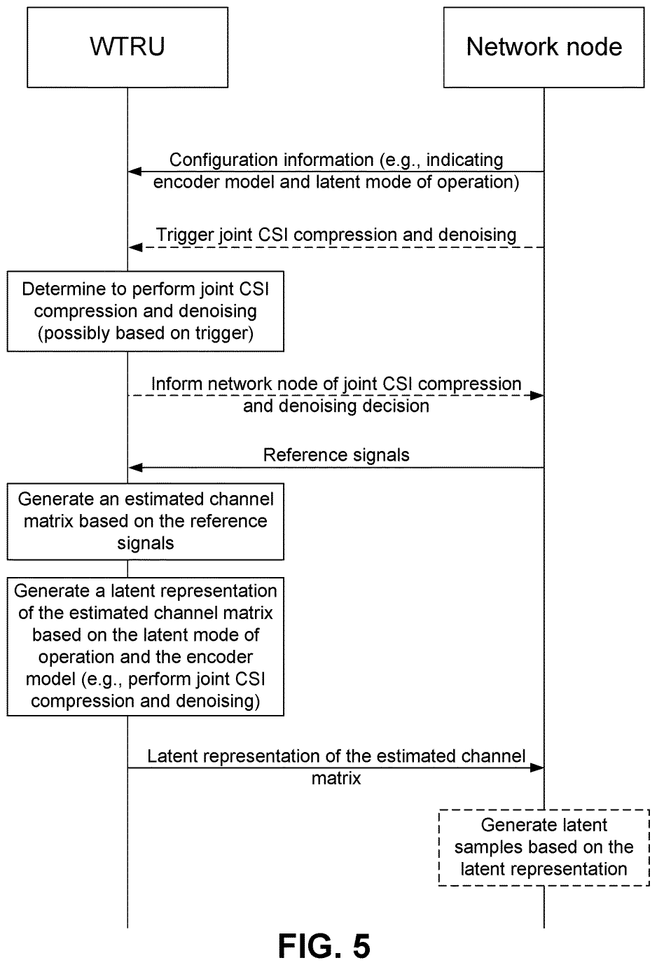

FIG. 5 is a flow diagram illustrating an example technique for joint CSI compression and denoising. As illustrated, a network node may send configuration information to a WTRU. The configuration information may indicate an encoder model and a latent mode of operation. The network node may trigger the WTRU to perform joint CSI compression and denoising. The WTRU may determine to perform joint CSI compression and denoising (e.g., based on the trigger). The WTRU may inform the network node of the joint CSI compression and denoising decision.

The network node may send reference signals (e.g., CSI-RS) to the WTRU. The WTRU may generate an estimated channel matrix based on the reference signals. The WTRU may generate a latent representation of the estimated channel based on the latent mode of operation and the encoder model (e.g., by performing joint CSI compression and denoising). The WTRU may send the latent representation of the estimated channel matrix to the network node.

In the distribution mode, latent representation may be vectors that represent a latent distribution associated with the estimated channel matrix (e.g., the mean and variance vectors, μ_{θ} and ν_{θ}). In this case, the network may generate latent samples based on the latent representation.

In the multiple latent mode, the WTRU may sample a Gaussian distribution based on the vectors to generate latent samples associated with the estimated channel matrix. In this case, the latent representation of the estimated channel matrix may be the latent samples.

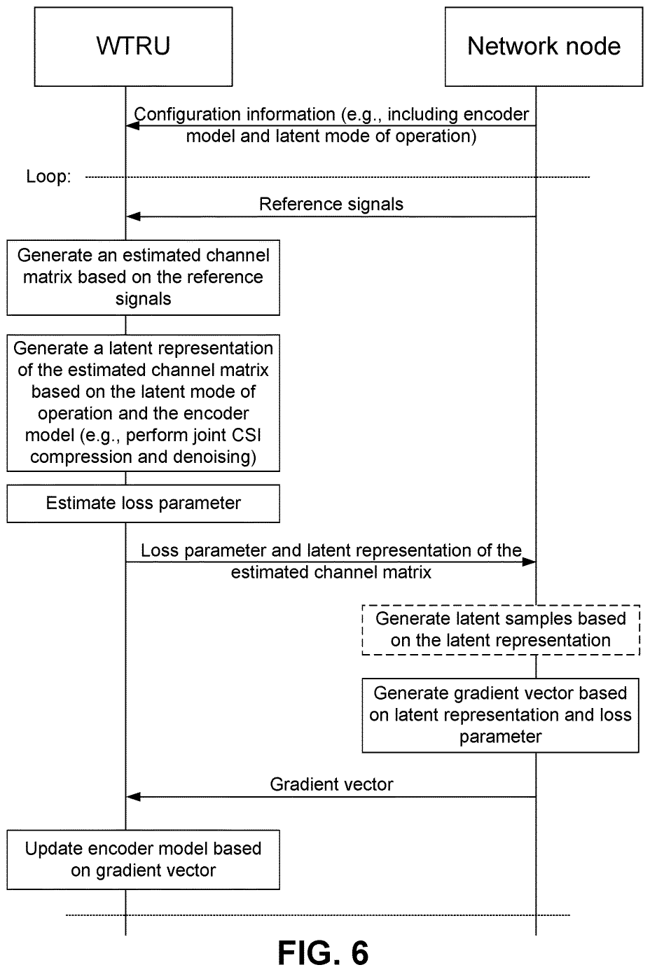

FIG. 6 is a flow diagram illustrating an example technique for online training of an encoder model used for joint CSI compression and denoising. As illustrated, a network node may send configuration information to a WTRU. The configuration information may indicate an encoder model and a latent mode of operation. Although not shown in FIG. 6, the network node may trigger the WTRU to perform joint CSI compression and denoising; the WTRU may determine to perform joint CSI compression and denoising (e.g., based on the trigger); and the WTRU may inform the network node of the joint CSI compression and denoising decision, as shown in FIG. 5.

The online training may involve the WTRU repeating one or more actions (e.g., in a loop). For example, the WTRU may receive reference signals (e.g., CSI-RS) from the network node. The WTRU may generate an estimated channel matrix based on the reference signals. The WTRU may generate a latent representation of the estimated channel based on the latent mode of operation and the encoder model (e.g., by performing joint CSI compression and denoising). The WTRU may estimate the value of a loss parameter. The WTRU may send the latent representation of the estimated channel matrix and the estimated loss parameter (e.g., the value of the estimated loss parameter) to the network node.

As described above, in the distribution mode, the network node may generate latent samples based on the latent representation (e.g., the mean and variance vectors). The network node may generate a gradient vector based on the latent representation and the loss parameter. The network node may send the gradient vector to the WTRU. The WTRU may update the encoder model based on the gradient vector.

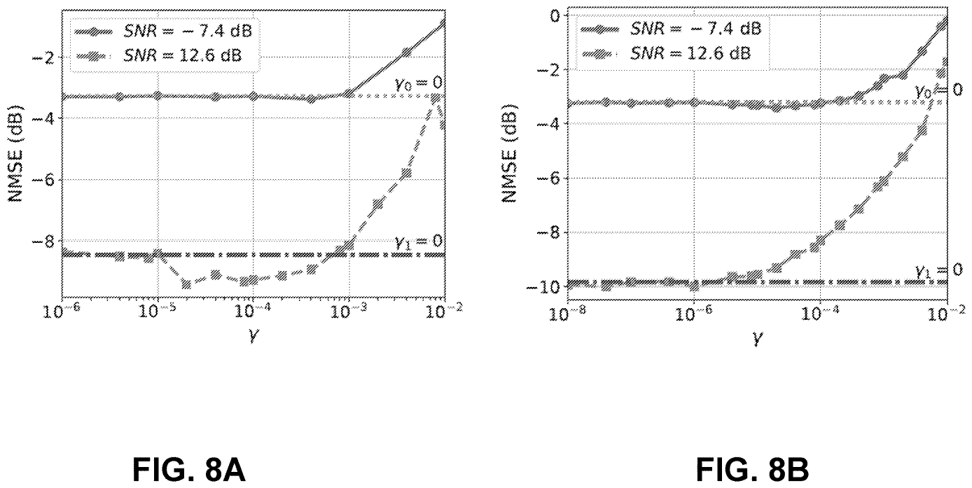

Example results are provided herein. FIGS. 8A and 8B illustrate results from employing VIB+SURE and/or NIB+SURE on a benchmark model (e.g., CsiNet). FIG. 8A illustrates the inference performance (e.g., inference performance based on an indoor dataset) of the VIB and NIB modes. The CsiNet model may rely on the true CSI (H). Aspects of the present disclosure consider the case where noisy CSI (e.g., only noisy CSI) is available. If only noisy CSI is available, the model described herein may treat the noisy CSI as the true CSI (e.g., ground truth). The noisy CSI may be denoted as “CsiNet (Noisy).” The reconstruction quality of CSI may be measured in normalized mean squared error (NMSE). The NMSE may be calculated between the reconstructed CSI (\tilde{H}) and the noise-free CSI (H). The joint denoising and compression approaches (e.g., VIB+SURE and NIB+SURE) may outperform the benchmark model (e.g., in the range of effective SNR evaluated).

In an example, a network node (e.g., a base station (BS) or gNB) may be equipped with N_{T} antennas for OFDM transmission over N_{C} subcarriers. In this case, a user (e.g., a single-antenna user) may observe (e.g., at the receiver side) a signal that may be expressed by the equation:

$${y}_{n} = {h}_{n}^{H} {v}_{n} {x}_{n} + {w}_{n} \qquad Eq . 10$$

where at the nth subcarrier, yₙ, denotes the received noisy symbol, hₙ∈ [symbol] ^{N}^{_{T}}^{×1} denotes the channel vector with the superscript H as the Hermitian operator, νₙ∈ [symbol] ^{N}^{_{T}}^{×1} denotes a precoding vector, xₙ∈ [symbol] denotes a transmitted symbol, and wₙ∈ [symbol] denotes additive noise. For example, the observed signal may include CSI reference signals. For example, the CSI reference signals may cover the full bandwidth of a bandwidth part (BWP) or a fraction of a BWP. The CSI-RS resources may be configured (e.g., in the time domain) as periodic, semi-persistent, or aperiodic.

By arranging channel vectors across all subcarriers, the channel matrix may be expressed as H=[h₁ . . . h_{N}_{_{c}}]^{H}, hence, H∈∈ [symbol] ^{N}^{_{c}}^{×N}^{_{T}}. The channel matrix H may be obtained by sending reference signals (e.g., νₙxₙ, also referred to as pilot signals) from the transmitter and estimating the reference signals at the receiver. In frequency division duplexed (FDD)-massive multiple input multiple output (MIMO) systems, N_{T}>>1. In this case, the channel matrix H may be a high-dimensional matrix (e.g., which may be burdensome to the system due to a large amount of CSI feedback). H may have a sparse representation in the angular-delay domain. This may reduce (e.g., significantly reduce) the CSI feedback burden. By applying a 2D-discreate Fourier transform (DFT) on H, the angular-delay form (H) may be expressed as:

$$\overline{H} = {F}_{a}^{H} {HF}_{d} \qquad Eq . 11$$

where Fₐ∈ [symbol] ^{N}^{_{T}}^{×N}^{_{T}} and F_{d}∈ [symbol] ^{N}^{_{c}}^{×N}^{_{c}} are two DFT matrices.

H̅ may be sparse (e.g., compared to H) in the sense that (e.g., most of) the signal power may be concentrated at the first Nₐ<<N_{T} angle-of-arrivals (e.g., other angle-of-arrivals may be negligible). Accordingly, H̅ may be truncated of its first Nₐ rows without losing much information from H.

The noisy truncated angular-delay domain CSI may be expressed as:

$$\tilde{H} = ⌊ \overline{H} + W ⌋ \qquad Eq . 12$$

where W is additive noise (e.g., with each entry w_{i,j}˜CN(0, 1/2), ∀i∈[N_{T}], ∀j∈[N_{C}], and where └⋅┘ denotes the truncation process).

H̅ may be reconstructed with noisy compressed CSI feedback \tilde{H}. Assuming sparsity, H may be denoted as H:=H̅, the truncated CSI in the angular-delay domain. \tilde{H} may represent the noisy estimate of the truncated CSI in the angular-delay domain.

Feature(s) associated with joint compression and denoising of CSI are provided herein. The joint compression and denoising of CSI feedback may be formulated into the following Markov chain: H→\tilde{H}→Z→Ĥ. Techniques are provided to find pair of encoder and decoder f_{θ}, g_{φ} parameterized through a class of learning models θ∈Θ, φ∈Φ. The mean square error (MSE) of the reconstructed CSI (Ĥ:=g(Z)) to the true CSI (H∈ [symbol] ^{K}) may be reduced (e.g., minimized). Mutual information between the noisy CSI (\tilde{H}) and a low-dimensional latent representation (Z:=f(\tilde{H}), z∈ [symbol] ^{L}) may be compressed (e.g., where and L≤N and at a predetermined level C₀>0).

The original complex CSI may be separated into real and imaginary image channels (e.g., by convention). The problem to be solved may be expressed in the constrained optimization form shown in Equation 13.

$${min}_{{f}_{0} ∈ Θ , {g}_{ϕ} ∈ Φ} E [ {‖ H - {g}_{ϕ} ( Z ) ‖}_{2}^{2} ] , \qquad Eq . 13$$

$$subject to I ( \tilde{H} ; Z ) \leq {C}_{0} ,$$

$$Z := {f}_{θ} ( \tilde{H} ) ,$$

$$H \to \tilde{H} \to Z \to {g}_{ϕ} ( Z )$$

The encoder may access (e.g., only access) the noisy CSI to form the latent representation. The MSE may be calculated with respect to the (e.g., unknown/hidden) true CSI. Using a Lagrange multiplier, Equation 13 may be rewritten as the following loss function:

$$\begin{matrix}ℒ := γ I ( \tilde{H} ; Z ) + E [ {‖ H - {g}_{ϕ} ( Z ) ‖}_{2}^{2} ] \\ = γ I ( \tilde{H} ; {f}_{θ} ( \tilde{H} ) ) + E [ {‖ H - {g}_{ϕ} ( {f}_{θ} ( \tilde{H} ) ) ‖}_{2}^{2} ]\end{matrix} \qquad Eq . 14$$

where γ is a trade-off parameter that is greater than 0. The trade-off parameter may be used to control the weighting between the two objectives.

Equation 14 may be difficult to solve without knowing the true CSI (e.g., H). Using SURE, the MSE term in Equation 14 may be estimated with (e.g., only) the noisy CSI (e.g., \tilde{H}).

Noisy CSI (e.g., only noisy CSI) may be accessible (e.g., in practice). In this case, joint denoising and compression of CSI feedback may be difficult. SURE may be used for unsupervised denoising (e.g., unsupervised image denoising may be accomplished with SURE).

A K-dimensional linear model (e.g., y=x+n, y∈ [symbol] ^{K}, where the noise n is additive Gaussian) may be considered. The noise n may be independently and identically distributed Gaussian, n˜ [symbol] (0,σ²I_{K}). In this case, given a moment-bounded estimator of x that accesses (e.g., only accesses) the observation y, (e.g., where ψ(y): [symbol] ), an unbiased estimate of the MSE (e.g., V(X, ψ(Y)):=E[∥ψ(Y)−X∥²]) may be represented as:

$$V ( ψ , y ) := {‖ ψ ( y ) - y ‖}_{2}^{2} - K {σ}^{2} + 2 {σ}^{2} {\sum }_{i = 1}^{K} \frac{{δψ}_{i} ( y )}{δ {y}_{i}} \qquad Eq . 15$$

where the last term of equation 15 denotes the divergence of the estimator ψ(y).

SURE may be extended to noise statistics that belong to the exponential family that applies to colored noise. It may be assumed that \tilde{H}=H+n. It may be assumed that n˜ [symbol] (0, σ²I_{K}) and that H and \tilde{H} are vectorized. With these assumptions, the MSE may be expressed as shown in equation 16.

$$V ( H , {g}_{ϕ} ( {f}_{θ} ( \tilde{H} ) ) ) = E [ {‖ {g}_{ϕ} ( {f}_{θ} ( \tilde{H} ) ) - \tilde{H} ‖}_{2}^{2} ] - K {σ}^{2} + 2 {σ}^{2} E [ {\sum }_{i = 1}^{K} \frac{δ {g}_{ϕ , i} ( {f}_{θ} ( \tilde{H} ) )}{δ {\tilde{H}}_{i}} ] \qquad Eq . 16$$

Equation 16 is independent of the true CSI (H). Equation 16 may be estimated using (e.g., only using) the noisy CSI (\tilde{H}). The divergence term in equation 16 may be difficult to optimize. Using a Monte-Carlo estimation technique, a set of standard normal Gaussian samples (e.g., w˜ [symbol] (0, I_{K}) may be generated. The divergence term may then be estimated (e.g., for a small value δ>0) as shown in equation 17.

$$E [ {\sum }_{i = 1}^{K} \frac{δ {g}_{ϕ , i} ( {f}_{θ} ( \tilde{H} ) )}{δ {\tilde{H}}_{i}} ] \approx \frac{1}{δ} {E}_{w} [ {\sum }_{i = 1}^{K} {g}_{ϕ , i} ( {f}_{θ} ( \tilde{H} + δ W ) ) - {g}_{ϕ , i} ( {f}_{θ} ( \tilde{H} ) ) ] \qquad Eq . 17$$

Feature(s) associated with estimating mutual information are provided herein. Mutual information (e.g., I(\tilde{H}; f_{θ}(\tilde{H}))) may be intractable in some cases (e.g., most cases). Using a variational inference approach (e.g., that is successful in supervised classification and unsupervised clustering tasks), a surrogate loss upper bound may be applied. The surrogate loss upper bound may allow the mutual information for be estimated.

Feature(s) associated with determining the surrogate loss upper bound (e.g., similar to that used in deriving the evidence lower bound (ELBO)) are provided herein. Given observations X as inputs, an encoder may be built that predicts a mean and variance pair (e.g., μ(x), ν²(x)). A set of independent and identically distributed standard norm samples, ε, may be shifted and scaled to produce outputs (e.g., z=μ+ve). For example, given certain inputs, outputs of the encoder may be distributed as [symbol] (μ(x), ν²(x)). Using this method of reparameterization, the upper bound of the mutual information may be expressed by the following closed-form equation:

$$I ( Z ; \tilde{H} ) \leq E [ log \frac{p ( Z \vert \tilde{H} )}{r ( Z )} ] = {E}_{\tilde{H}} [ - \frac{1}{2} {\sum }_{i = 1}^{d} [ log {v}_{i}^{2} + 1 - ( {μ}_{i}^{2} + {v}_{i}^{2} ) ] ] \qquad Eq . 18$$

where d is the dimension of the latent representation | [symbol] |=d, and r(Z) is the d-dimensional standard normal density function (e.g., served as a reference functional). The re-parameterized mean, μᵢ(\tilde{H}), and variance,

$${v}_{i}^{2} ( \tilde{H} ) ,$$

are functions of \tilde{H} (e.g., although the notation may be simplified for clarity of presentation).

Equation 18 may be estimated through Monte-Carlo sampling over batched (e.g., mini batches) of training data. Such sampling may be expressed as:

$$E [ log \frac{p ( Z \vert \tilde{H} )}{r ( Z )} ] \approx \frac{1}{B} {\sum }_{b = 1}^{B} \{ - \frac{1}{2} {\sum }_{i = 1}^{d} [ log {v}_{i}^{2} ( {\tilde{h}}_{b} ) + 1 - ( {μ}_{i}^{2} ( {\tilde{h}}_{b} ) + {v}_{i}^{2} ( {\tilde{h}}_{b} ) ] \} \qquad Eq . 19$$

where B is the size of a batch (e.g., of a mini batch).

The mutual information may also be estimated by assuming the reference density function r (Z) is a Gaussian mixture. The mutual information estimation may be represented as:

$$I ( Z ; \tilde{H} ) = H ( Z ) - H ( Z \vert \tilde{H} ) \leq {H}_{r} ( Z ) - H ( Z \vert \tilde{H} ) \qquad Eq . 20$$

where Hᵣ(Z) denotes the Gaussian mixture entropy.

If the Gaussian mixture has a same variance (e.g., ν²) across components and among elements, (e.g., zⱼ˜ [symbol] (μⱼ, ν²I_{d}), ∀cⱼ∈ [symbol] ), the resultant upper bound of the Gaussian mixture entropy may be expressed in closed-form. If the upper bound is considered with the re-parameterization result, the following upper bound of the mutual information may be derived:

$$I ( Z ; \tilde{H} ) \leq - {E}_{x} [ {E}_{{x}^{′}} [ {\sum }_{{c}_{i}} {p}_{{c}_{i} \vert x} log {\sum }_{{c}_{j}} {p}_{{c}_{j} \vert {x}^{′}} {e}^{- \frac{1}{2 {v}^{2}} d ( {μ}_{{c}_{i} \vert x} ‖ {μ}_{{c}_{j} \vert {x}^{′}} )} ] ] \qquad Eq . 21$$

where d(⋅∥⋅) is the pair-wise distance function defined as:

$$d ( {μ}_{{c}_{i} \vert x} ‖ {μ}_{{c}_{j} \vert {x}^{′}} ) = {( {μ}_{{c}_{i} \vert x} - {μ}_{{c}_{j} \vert {x}^{′}} )}^{T} ( {μ}_{{c}_{i} \vert x} - {μ}_{{c}_{j} \vert {x}^{′}} ) \qquad Eq . 22$$

Example estimators are provided herein. One or more (e.g., two) estimators may be used in supervised or unsupervised settings (e.g., with respect to the system's knowledge of the true CSI (H)). In an unsupervised scenario, Equation 17 and Equation 19 may be substituted into Equation 14 to obtain the following estimator expressed in Equation 23:

$$ℒ \approx \frac{1}{B} {\sum }_{b = 1}^{B} \{ {‖ {g}_{ϕ} ( {f}_{θ} ( {\tilde{h}}_{b} ) ) - {\tilde{h}}_{b} ‖}_{2}^{2} - K {σ}^{2} + \frac{2 {σ}^{2}}{δ} {\sum }_{i = 1}^{K} {w}_{b , i} [ {g}_{ϕ , i} ( {f}_{θ} ( {\tilde{h}}_{b} + δ {w}_{b} ) ) - {g}_{ϕ , i} ( {f}_{θ} ( {\tilde{h}}_{b} ) ) ] - \frac{γ}{2} {\sum }_{j = 1}^{d} [ log {v}_{j}^{2} ( {\tilde{h}}_{b} ) + 1 - {μ}_{j}^{2} ( {\tilde{h}}_{b} ) - {v}_{j}^{2} ( {\tilde{h}}_{b} ) ] \} \qquad Eq . 23$$

where b denotes the batch (e.g., mini batch) index, i denotes the index of the CSI and its reconstruction, j denotes the index for the latent dimension, and w_{b,i} denotes the sampled standard normal noise in the bth batch (e.g., mini batch) for the ith element of a CSI sample. The estimator may be a loss function that may be used to solve the problem expressed in Equation 13.

The solution to Equation 23 can be estimated without knowing the true CSI (H) (e.g., because the noisy CSI (\tilde{H}) is the only input for Equation 23). The solution to Equation 23 may be estimated in an unsupervised fashion. If the true CSI (H) is known, the estimator can be adjusted for a supervised setting. For examples, the estimator may be adjusted for a supervised setting by replacing the SURE estimator with the standard MSE:

$${ℒ}^{*} \approx \frac{1}{B} {\sum }_{b = 1}^{B} \{ {‖ {g}_{ϕ} ( {f}_{θ} ( {\tilde{h}}_{b} ) ) - {\tilde{h}}_{b} ‖}_{2}^{2} - \frac{1}{2} {\sum }_{j = 1}^{d} [ log {v}_{j}^{2} ( {\tilde{h}}_{b} ) + 1 - {μ}_{j}^{2} ( {\tilde{h}}_{b} ) - {v}_{j}^{2} ( {\tilde{h}}_{b} ) ] \} \qquad Eq . 24$$

In Equations 23 and 24, the estimators for mutual information I(Z; X) may be replaced with Equation 21. The estimators may then be used to obtain alternative loss functions that may be used to solve the problem in Equation 13.

Minimizing (e.g., explicitly minimizing) the mutual information I(Z; X) may serve as a regularization of the learning model and trade-off the reconstruction quality (e.g., relevance) and/or the complexity of the latent representation. Experimental results may be provided. The experimental results may show the existence of an optimal trade-off when the target (e.g., true CSI) is hidden while the noisy estimate of the CSI is accessible.

In a first example, the trade-off parameter γ for the estimators (e.g., two variational inference-based mutual information estimators) may be selected in a supervised learning setting. The trade-off parameter γ may be varied in low and high SNR regimes. In a second example, the SURE estimator may be incorporated for unsupervised learning. The best-performing γ in the first example may be selected. The step-size for a Monte-Carlo estimation of the divergence in SURE estimator may then be varied. Given the two hyper-parameters, the number of dimensions of the latent representation layer may be varied (e.g., thereby varying the compression ratio) in low and high SNR regimes.

Feature(s) associated with implementation and datasets are provided herein. The loss functions provided herein may be applicable without changing the architecture of a decoder. The loss functions provided herein may be applicable with some (e.g., minimal) modification to architecture of an encoder.

In some examples, CsiNet may be adopted as the baseline. The fully connected bottleneck layer of the CsiNet may be replaced with variational encoders (e.g., in equations 21 and 22). The compression ratio may therefore be expressed as:

$$μ := \frac{d}{K} \qquad Eq . 25$$

where d is the output dimension of the bottleneck layer, and K is the dimension (e.g., separating real and complex parts) of a CSI data sample.

The indoor dataset used in CsiNet may serve as the true CSI matrices (e.g., for comparison purposes). Zero-mean circular complex Gaussian noise may be added to each entry with a controlled noise variance, as shown in equation 26:

$$\tilde{H} = H + σ n , {n}_{i} ∼ C 𝒩 ( 0 , 1 ) , ∀ i ϵ [ K ] \qquad Eq . 26$$

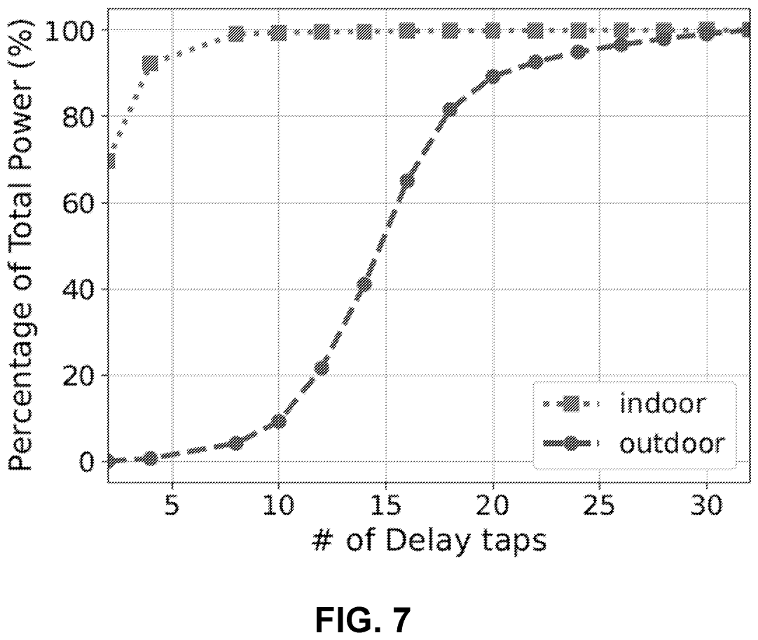

The value of σ may be 10⁻¹ (e.g., effective SNR≈−7.43 dB) as the low SNR scenario. The value of σ may be 10⁻² (e.g., effective SNR≈12.6 dB) for the high SNR scenario. There may be a mapping between σ and the SNR of the indoor CsiNet data. As illustrated in FIG. 7, the effective SNR may be the percentage of signal power that first reaches 99% with respect to increasing delay taps. FIG. 7 illustrates the sparsity in the angular-delay domain of the indoor/outdoor dataset. The average squared norm per CSI sample of the testing indoor data may be approximately Eᵢₙ≈0.93. The average squared norm per CSI sample of the testing outdoor data may be approximately Eₒᵤₜ≈1.64.

Feature(s) associated with compression as regularization with noisy CSI are provided herein. The examples provided herein may have one or more (e.g., two) hyper-parameters to select. For example, the hyper parameters may include the MSE-compression trade-off multiplier γ and the step-size ε for the Monte-Carlo numerical divergence estimation.

The value of ε may be selected using image denoising techniques. For example, a high ε may incur significant estimation error. For example, a small ε may result in numerical instability. The techniques provided herein may experience a similar trade-off. An empirical study of γ (e.g., only γ) may be provided (e.g., instead of jointly evaluating the two hyperparameters). The proposed loss functions apply to supervised learning settings.

When the observation is noise-free (e.g., as in the case of standard autoencoder training with fixed neurons of the bottleneck layer), signals without explicit compression may retain information (e.g., most information) for reconstruction. When the observation is noisy, compression of the latent features may be provided in addition to dimensional compression (e.g., dimension reduction).

Regularization may be used on the loss function during training phase (e.g., to avoid overfitting, generalization accuracy). For example, the compression term in IB methods may have regularization effects. The loss functions provided herein may therefore strike a balance between reconstruction quality and generalization error.

An average SNR for injecting noise to the indoor dataset of CsiNet may be fixed. The examples provided herein may be trained with a range of trade-off parameters (e.g., γ∈[0, 10⁻²]). If γ=0, the loss functions may depend on MSE (e.g., MSE only) (e.g., SURE for unsupervised case).

FIGS. 8A and 8B illustrate the MSE-compression trade-off in supervised settings. FIGS. 8A and 8B illustrate the effect of γ (e.g., in both high and low SNR regimes). The horizontal line in each of FIGS. 8A and 8B may correspond to the cases γ0=0 for low SNR and γ1=0 for high SNR, respectively. The latent dimensions of the two methods (e.g., VIB mode and NIB mode) may be 128. The compression ratio may be 1/8. γ=0 may correspond to the case where MSE is the loss function (e.g., only loss function) involved in the training phase of the models. In FIGS. 8A and 8B, there exist non-zero values of γ such that the reconstruction quality is optimized (e.g., for the range explored). If the NMSE achieved is lower than that of the line corresponding to γᵢ=0, i∈{0, 1}, than there exists a value (e.g., an optimal choice) of the trade-off parameter γ* that attains a reconstruction quality (e.g., optimal reconstruction quality) for testing CSI samples. The trade-off parameter may be selected. For example, the selected trade-off parameter may be different for different latent modes of operation (e.g., γᵥ=10⁻⁵ for the VIB-based mode, and γₙ=10⁻⁶ for the NIB-based mode).

Examples of changes from supervised to unsupervised CSI denoising are provided herein. A value (e.g., an optimal value) of the trade-off parameter γ may be selected. The latent modes of operation may be compared in different SNR (e.g., through controlled additive Gaussian noise). The SURE estimator may be an unbiased MSE with respect to noisy CSI (e.g., assuming knowledge of noise power (justified through a noise level estimation phase). The SURE estimator may therefor enable unsupervised learning. To compare CsiNet in the unsupervised scenario, the loss function of CsiNet may be replaced with SURE. The resulting unsupervised compared scheme may be referred to as CsiSURE. SURE may introduce an extra hyperparameter ε for Monte-Carlo estimation of the divergence. The value of ε may be selected using an appropriate selection method.

The reconstruction qualities between the three modes (e.g., CsiNet, NIB mode, and VIB mode) may be compared in different SNR regimes. A change in performance between supervised to unsupervised learning may be compared for the three modes (e.g., CsiNet, NIB mode, and VIB mode).

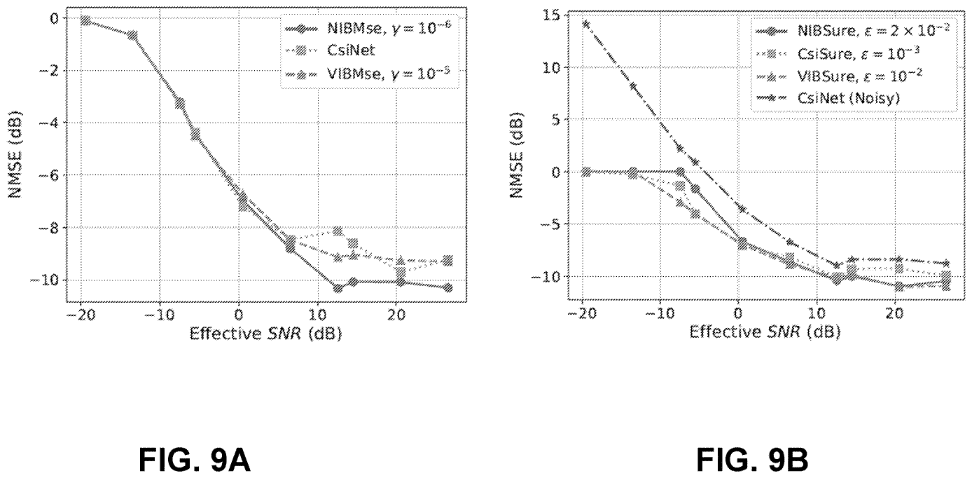

FIGS. 9A and 9B illustrate a comparison of the three modes (e.g., CsiNet, NIB mode, and VIB mode). FIG. 9A illustrates a comparison of the methods provided herein (e.g., VIB mode and NIB mode) to CsiNet in a supervised setting. As illustrated, the NIB mode and VIB mode may perform better in the high SNR regime. This may be due to the explicit compression.

FIG. 9B illustrates a comparison of the modes provided herein (e.g., VIB mode and NIB mode) to CsiSURE in an unsupervised setting. As illustrated, the performance gain (e.g., due to explicit compression) may persist in high SNR regimes. The VIB mode may extend the improvement to unsupervised setting (e.g., see unsupervised low SNR case in FIG. 9B). FIG. 9B illustrates a comparison of the modes provided herein (e.g., VIB mode and NIB mode) to CsiNet trained with noisy CSI (e.g., only noisy CSI) in an unsupervised setting. As illustrated, using SURE may improve the reconstruction quality in all SNR regimes (e.g., all SNR regimes that were considered).

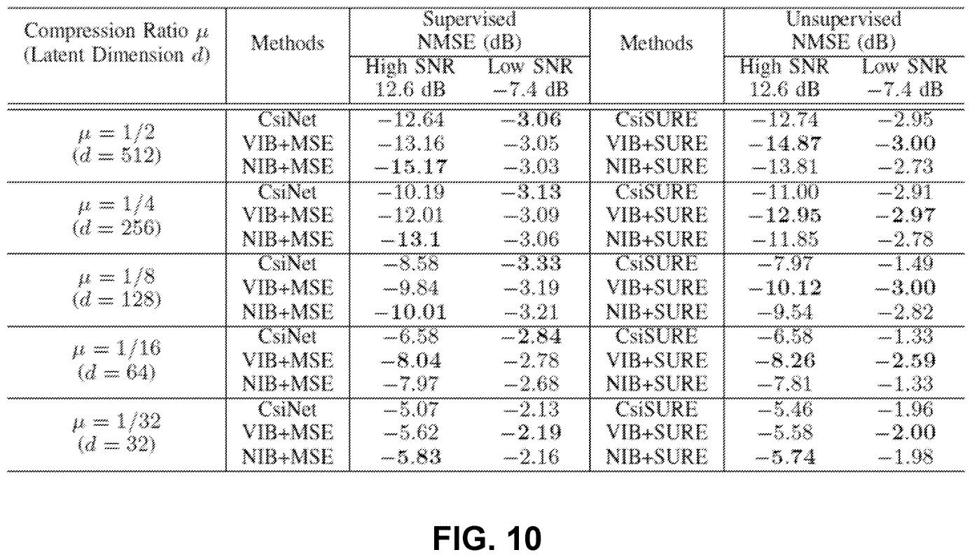

An example compression ratio with noisy CSI may be provided. A comparison of overall reconstruction quality under different compression ratios may be provided. FIG. 10 is a table that summarizes the methods discussed above. As shown, the table in FIG. 10 may be divided into supervised and unsupervised groups. For each group, each method may be evaluated in high and low SNR regimes (e.g., for a fixed compression ratio). The methods provided herein (e.g., VIB mode and NIB mode) outperform CsiNet in the high SNR case (e.g., with non-negligible improvement). This may imply an advantage of explicit compression in varying compression ratio.

In the unsupervised scenario, the modes provided herein (e.g., VIB mode and NIB mode) outperform CsiSURE. The combination of SURE and explicit compression enables unsupervised training. The combination enables higher reconstruction quality from noisy CSI in a wider range of SNR regimes and compression ratios.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-14. (canceled)

15. A wireless transmit/receive unit (WTRU) comprising:
a processor configured to:
receive configuration information, wherein the configuration information indicates a latent mode of operation, from a plurality of latent modes of operation, and an encoder model;
receive channel state information (CSI) reference signals from a network node;
generate an estimated channel matrix based on the CSI reference signals;
generate a latent representation of the estimated channel matrix based on the latent mode of operation and the encoder model, wherein a format of the latent representation depends on the latent mode of operation; and
send the latent representation of the estimated channel matrix to the network node.

16. The WTRU of claim 15, wherein the processor is further configured to generate vectors that represent a latent distribution associated with the estimated channel matrix.

17. The WTRU of claim 15, wherein the latent mode of operation comprises a multiple latent mode, and the processor being configured to generate the latent representation of the estimated channel matrix based on the latent mode of operation and the encoder model comprises the processor being configured to:
generate vectors that represent a latent distribution associated with the estimated channel matrix; and
sample a Gaussian distribution based on the vectors to generate latent samples associated with the estimated channel matrix, wherein the latent representation of the estimated channel matrix comprises the latent samples.

18. The WTRU of claim 15, wherein the latent mode of operation comprises a distribution mode, and the processor being configured to generate the latent representation of the estimated channel matrix based on the latent mode of operation and the encoder model comprises the processor being configured to generate vectors that represent a latent distribution associated with the estimated channel matrix, wherein the latent representation of the estimated channel matrix comprises the vectors.

19. The WTRU of claim 15, wherein the processor is further configured to:
estimate a training loss parameter value based on a property of the estimated channel matrix;
transmit the training loss parameter value to the network node;
receive, from the network node, a gradient vector associated with the latent representation and the training loss parameter value; and
update the encoder model based on the gradient vector.

20. The WTRU of claim 19, wherein the property of the estimated channel matrix comprises one or more of: a doppler spread, a delay spread, a signal to noise ratio (SNR), or a channel rank.

21. The WTRU of claim 15, wherein the processor is further configured to:
determine, based on the estimated channel matrix, to perform CSI denoising; and
transmit an indication of the determination to the network node, wherein the latent representation of the estimated channel matrix is generated further based on the determination.

22. The WTRU of claim 15, wherein the latent mode of operation and the encoder model are associated with joint denoising and compression of CSI feedback.

23. A method comprising:
receiving configuration information, wherein the configuration information indicates a latent mode of operation, from a plurality of latent modes of operation, and an encoder model;
receiving channel state information (CSI) reference signals from a network node;
generating an estimated channel matrix based on the CSI reference signals;
generating a latent representation of the estimated channel matrix based on the latent mode of operation and the encoder model, wherein a format of the latent representation depends on the latent mode of operation; and
sending the latent representation of the estimated channel matrix to the network node.

24. The method of claim 23, wherein the method further comprises generating vectors that represent a latent distribution associated with the estimated channel matrix.

25. The method of claim 23, wherein the latent mode of operation comprises a multiple latent mode, and generating the latent representation of the estimated channel matrix based on the latent mode of operation and the encoder model comprises:
generating vectors that represent a latent distribution associated with the estimated channel matrix; and
sampling a Gaussian distribution based on the vectors to generate latent samples associated with the estimated channel matrix, wherein the latent representation of the estimated channel matrix comprises the latent samples.

26. The method of claim 23, wherein the latent mode of operation comprises a distribution mode, and generating the latent representation of the estimated channel matrix based on the latent mode of operation and the encoder model comprises generating vectors that represent a latent distribution associated with the estimated channel matrix, wherein the latent representation of the estimated channel matrix comprises the vectors.

27. The method of claim 23, wherein the method further comprises:
estimating a training loss parameter value based on a property of the estimated channel matrix;
transmitting the training loss parameter value to the network node;
receiving, from the network node, a gradient vector associated with the latent representation and the training loss parameter value; and
updating the encoder model based on the gradient vector.

28. The method of claim 27, wherein the property of the estimated channel matrix comprises one or more of: a doppler spread, a delay spread, a signal to noise ratio (SNR), or a channel rank.

29. The method of claim 23, wherein the method further comprises:
determining, based on the estimated channel matrix, to perform CSI denoising; and
transmitting an indication of the determination to the network node, wherein the latent representation of the estimated channel matrix is generated further based on the determination.

30. The method of claim 23, wherein the latent mode of operation and the encoder model are associated with joint denoising and compression of CSI feedback.
